(19) United States
(12) Patent Application Publication
(10) Pub. No.: US 2026/0360815 A1
(43) Pub. Date: Nov. 12, 2026

(54) NON-AQUEOUS SECONDARY BATTERY

(71) Applicant: TOYOTA JIDOSHA KABUSHIKI KAISHA, Toyota-shi (JP)

(72) Inventors: Tsukasa Yamaguchi, Toyota-shi (JP); Kyosuke Yoshida, Susono-shi (JP)

(73) Assignee: TOYOTA JIDOSHA KABUSHIKI KAISHA, Toyota-shi (JP)

(21) Appl. No.: 19/542,855

(22) Filed: Feb. 18, 2026

(30) Foreign Application Priority Data
May 8, 2025 (JP) 2025-077731

(51) Int. Cl. H01M 10/0567; H01M 4/58; H01M 10/0525; H01M 10/0568; H01M 10/0569; H01M 10/42

(52) U.S. Cl. CPC H01M 10/0567; H01M 4/5825; H01M 10/0525; H01M 10/0568; H01M 10/0569; H01M 10/4235; H01M 2300/0037

(57) ABSTRACT

A non-aqueous secondary battery including a positive electrode current collector foil, a positive electrode layer containing a positive electrode active material, an electrolyte layer containing a separator and a non-aqueous electrolyte solution, a negative electrode layer, and a negative electrode current collector foil, in which the positive electrode active material is lithium manganese iron phosphate (LMFP), a basis weight of the positive electrode layer is 20 mg/cm² or more, the non-aqueous electrolyte solution contains lithium bis(fluorosulfonyl)imide (LiFSI) as a lithium salt, a sulfonamide compound as an additive, and a cyclic carbonate compound and an ester compound as solvents, a concentration of the lithium salt in the non-aqueous electrolyte solution is 1.4 M or more, and the sulfonamide compound is at least one of N,N-dimethyltrifluoromethanesulfonamide (CF₃SO₂N(CH₃)₂) and N,N-dimethylsulfamoyl fluoride ((CH₃)₂NSO₂F).

### CROSS-REFERENCE TO RELATED APPLICATION

This application claims priority to Japanese Patent Application No. 2025-077731 filed on May 8, 2025. The disclosure of the above-identified application, including the specification, drawings, and claims, is incorporated by reference herein in its entirety.

### BACKGROUND

### 1. Technical Field

The present disclosure relates to a non-aqueous secondary battery.

### 2. Description of Related Art

Various techniques have been proposed for a non-aqueous secondary battery using a non-aqueous electrolyte solution as disclosed in Japanese Patent No. 6260735 (JP 6260735 B) and Japanese Patent No. 7559253 (JP 7559253 B).

### SUMMARY

In the related art, various non-aqueous electrolyte solutions have been proposed in order to obtain the non-aqueous secondary battery having high battery characteristics. The non-aqueous electrolyte solution contains, for example, an electrolyte such as a lithium salt, and a non-aqueous solvent.

The non-aqueous solvent, such as methyl propionate (MP), constituting the non-aqueous electrolyte solution may undergo oxidative decomposition at a positive electrode under environmental conditions such as a high temperature, humidity, and a high voltage. A decomposition product produced in a process of the oxidative decomposition of the non-aqueous solvent may react with a positive electrode material, and thus a structure or electrochemical characteristics of the positive electrode may deteriorate.

Meanwhile, a film mainly containing lithium oxide, lithium carbonate, lithium alkyl carbonate, lithium fluoride (LiF), and the like is provided on a surface of a negative electrode by a reaction between the negative electrode and a lithium ion or a reaction between the negative electrode and the non-aqueous solvent. The film is called a solid electrolyte interface (SEI), and the film is known to have an effect of protecting the surface of the negative electrode and suppressing reductive decomposition of the solvent, thereby suppressing a decrease in battery performance. A by-product produced by deterioration of the non-aqueous solvent such as MP causes a decrease in reactivity of the negative electrode and causes the SEI to be unstable.

In order to improve the battery performance of the non-aqueous secondary battery, an attempt has been made to promote formation of the SEI by adding an additive to the non-aqueous electrolyte solution. Meanwhile, when lithium bis(fluorosulfonyl)imide (LiFSI) is used as the lithium salt, formation of the LiF that is a significant component of the SEI is presumed to be difficult. As a result, the formation of the SEI at the negative electrode may not sufficiently proceed, and stable battery performance may fail to be achieved.

In addition, lithium manganese iron phosphate (LMFP) has been attracting attention as a positive electrode active material because of excellent durability. Meanwhile, under the severe environmental conditions, deterioration of the non-aqueous electrolyte solution as described above occurs, and thus, in the non-aqueous secondary battery in the related art, there is a problem in that an effect of using the LMFP as the positive electrode active material cannot be sufficiently exhibited.

The present disclosure has been made in view of the circumstances, and a main object thereof is to provide a non-aqueous secondary battery that can promote formation of SEI and suppress a decrease in performance even when LiFSI is used as a lithium salt.

That is, the present disclosure includes the following aspects.
<1> A non-aqueous secondary battery including a positive electrode current collector foil, a positive electrode layer containing a positive electrode active material, an electrolyte layer containing a separator and a non-aqueous electrolyte solution, a negative electrode layer, and
a negative electrode current collector foil,
in which the positive electrode active material is lithium manganese iron phosphate (LMFP), a basis weight of the positive electrode layer is 20 mg/cm² or more,
the non-aqueous electrolyte solution contains lithium bis(fluorosulfonyl)imide (LiFSI) as a lithium salt, a sulfonamide compound as an additive, and a cyclic carbonate compound and an ester compound as a solvent,
a concentration of the lithium salt in the non-aqueous electrolyte solution is 1.4 M or more, and
the sulfonamide compound is at least one of N,N-dimethyltrifluoromethanesulfonamide (CF₃SO₂N(CH₃)₂) and N,N-dimethylsulfamoyl fluoride ((CH₃)₂NSO₂F).
<2> The non-aqueous secondary battery according to <1>, in which a volume ratio of the cyclic carbonate compound to the ester compound is 0.17 or more, the cyclic carbonate compound is at least one of ethylene carbonate (EC) and propylene carbonate (PC), and
the ester compound is at least one selected from the group consisting of methyl acetate (MA), methyl propionate (MP), ethyl acetate (EA), ethylene propionate (EP), and propyl propionate (PP).
<3> The non-aqueous secondary battery according to <1> or <2>,
in which the non-aqueous electrolyte solution further contains vinylene carbonate (VC) as the additive,
1.0% by mass or more of the vinylene carbonate is contained, as the additive, in the non-aqueous electrolyte solution, and
1.0% by mass or more of the sulfonamide compound is contained, as the additive, in the non-aqueous electrolyte solution.
<4> The non-aqueous secondary battery according to any one of <1> to <3>, in which the non-aqueous electrolyte solution further contains LiX as the lithium salt, and the LiX is at least one of LiPF₆ and LiBF₄.
<5> The non-aqueous secondary battery according to <4>, in which a concentration ratio of the LiFSI to the LiX (LiFSI/LiX) is 2.5 or more, the LiFSI and the LiX being contained in the non-aqueous electrolyte solution.

According to the present disclosure, it is possible to provide the non-aqueous secondary battery that can promote the formation of the SEI and suppress the decrease in the performance even when the LiFSI is used as the lithium salt.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing an initial IV resistance of an embodiment and Comparative Examples;

FIG. 2 is a graph showing a relationship between an elapsed time and a convergence current (mA) in a float test of the embodiment and Comparative Examples;

FIG. 3 is a graph showing a convergence-current cumulative value of the embodiment and Comparative Examples;

FIG. 4 is a graph showing a discharge capacity retention rate of the embodiment and Comparative Examples; and

FIG. 5 is a graph showing an IV resistance increase rate of the embodiment and Comparative Examples.

### DETAILED DESCRIPTION OF EMBODIMENTS

Embodiments according to the present disclosure will be described below. It is noted that matters needed for implementing the present disclosure other than the matters particularly mentioned in the present specification can be understood as design matters of those skilled in the art based on the related art in the field. Examples of matters needed for implementing the present disclosure include a general configuration and a manufacturing process of a non-aqueous secondary battery that does not characterize the present disclosure. The present disclosure can be carried out based on the contents disclosed in the present specification and the common general technical knowledge in the field.

In the present disclosure, the average particle diameter of particles is a median diameter (D50) which is a particle diameter at a cumulative value of 50% in a volume-based particle size distribution measured by a laser diffraction and scattering type particle size distribution measurement, unless otherwise specified.

In the present disclosure, there is provided a non-aqueous secondary battery including a positive electrode current collector foil, a positive electrode layer containing a positive electrode active material, an electrolyte layer containing a separator and a non-aqueous electrolyte solution, a negative electrode layer, and a negative electrode current collector foil,
in which the positive electrode active material is lithium manganese iron phosphate (LMFP), a basis weight of the positive electrode layer is 20 mg/cm² or more,
the non-aqueous electrolyte solution contains lithium bis(fluorosulfonyl)imide (LiFSI) as a lithium salt, a sulfonamide compound as an additive, and a cyclic carbonate compound and an ester compound as solvents,
a concentration of the lithium salt in the non-aqueous electrolyte solution is 1.4 M or more, and
the sulfonamide compound is at least one of N,N-dimethyltrifluoromethanesulfonamide (CF₃SO₂N(CH₃)₂) and N,N-dimethylsulfamoyl fluoride ((CH₃)₂NSO₂F).

In the non-aqueous secondary battery according to the present disclosure, the use of a non-aqueous electrolyte solution in which LiFSI as the lithium salt, the specific sulfonamide compound as the additive, and the cyclic carbonate compound and the ester compound as the solvent are combined successfully suppressed a side reaction and suppressed a decrease in battery performance. This is considered to be because, in the non-aqueous secondary battery according to the present disclosure, despite the use of LiFSI as the lithium salt, LiF that is a significant component of the SEI is effectively supplied to the negative electrode, and the formation of the SEI in the negative electrode can be promoted. In addition, in the non-aqueous secondary battery according to the present disclosure, since LMFP having excellent durability is used as the positive electrode active material, and the battery performance is stabilized by the non-aqueous electrolyte solution, it can be said that an environment in which the effect of improving the durability by LMFP is easily exhibited is provided.

### 1. Electrolyte Layer

Hereinafter, the electrolyte layer, the positive electrode current collector foil, the positive electrode layer, the negative electrode current collector foil, and the negative electrode layer constituting the non-aqueous secondary battery according to the present disclosure will be described in order. It is noted that the non-aqueous secondary battery according to the present disclosure has a structure in which a positive electrode including a positive electrode current collector foil and a positive electrode layer, the electrolyte layer, and a negative electrode including a negative electrode layer and a negative electrode current collector foil are laminated in this order, and the electrolyte layer is disposed between the positive electrode layer and the negative electrode layer.

The electrolyte layer is a layer containing a separator and a non-aqueous electrolyte solution. The separator is impregnated with the non-aqueous electrolyte solution and prevents the positive electrode layer and the negative electrode layer from coming into contact with each other. The material of the separator is not particularly limited as long as it is a porous film, and examples thereof include resins such as polyethylene (PE), polypropylene (PP), polyester, polyvinyl alcohol, cellulose, and polyamide. In addition, the separator may have a single-layer structure or a multi-layer structure. Examples of the separator having a multi-layer structure include a separator having a two-layer structure of PE/PP, and a separator having a three-layer structure of PP/PE/PP or PE/PP/PE.

The separator may be a nonwoven fabric such as a resin nonwoven fabric and a glass fiber nonwoven fabric.

In the non-aqueous secondary battery according to the present disclosure, the non-aqueous electrolyte solution contains LiFSI as a lithium salt, a specific sulfonamide compound as an additive, and a cyclic carbonate compound and an ester compound as a solvent.

The non-aqueous electrolyte solution contains LiFSI (chemical formula LiN(SO₂F)₂) as an indispensable component of a lithium salt. The non-aqueous electrolyte solution may contain solely LiFSI that is an imide salt as the lithium salt, or may contain other lithium salts other than LiFSI. Examples of the other lithium salts include imide salts such as lithium bis(trifluoromethanesulfonyl)imide (LiTFSI) and lithium bis(pentafluoroethylsulfonyl)imide (LiBETI). In addition, examples of the other lithium salts include organic lithium salts such as LiCF₃SO₃ and LiC(SO₂CF₃)₃. In addition, inorganic lithium salts (LiX) such as LiPF₆, LiBF₄, LiClO₄, and LiAsF₆ can also be used as the lithium salt. The other lithium salts may be at least one LiX of LiPF₆ and LiBF₄. Among these, LiPF₆ tends to shift, by its equilibrium reaction, toward promoting the production of LiF under high-temperature conditions, and thus functions as a significant supply source of LiF. The other lithium salts may be used alone or in combination of two or more kinds thereof.

The non-aqueous electrolyte solution may contain LiFSI as a main lithium salt. Here, the non-aqueous electrolyte solution containing LiFSI as the main lithium salt means that a concentration of LiFSI contained in the non-aqueous electrolyte solution is higher than a total concentration of other lithium salts contained in the non-aqueous electrolyte solution. For example, in a case where LiFSI and at least one LiX of LiPF₆ and LiBF₄ are used in combination as the lithium salt, the concentration ratio may be as follows. That is, a concentration ratio (LiFSI/LiX) of LiFSI to LiX contained in the non-aqueous electrolyte solution may be 2.5 or more, 100.0 or less, or 10.0 or less.

A concentration of the lithium salt in the non-aqueous electrolyte solution is 1.4 M or more, and may be 2.0 M or more, 6.0 M or less, or 4.0 M or less. By setting the lithium salt concentration to 1.4 M or more, a non-aqueous electrolyte solution having excellent ion conductivity is obtained. In a case where the lithium salt concentration is high, the viscosity of the non-aqueous electrolyte solution is high, and the ion conductivity may be decreased. However, in the non-aqueous secondary battery according to the present disclosure, by combining the cyclic carbonate compound and the ester compound as the solvent, it is possible to suppress a decrease in ion conductivity.

The sulfonamide compound contained in the non-aqueous electrolyte solution is at least one of N,N-dimethyltrifluoromethanesulfonamide (DMeTFSA) and N,N-dimethylsulfamoyl fluoride ((CH₃)₂NSO₂F). By containing the sulfonamide compound, LiF can be effectively supplied to the negative electrode, and the formation of the SEI can be promoted. The sulfonamide compound c may be solely one of N,N-dimethyltrifluoromethanesulfonamide and N,N-dimethylsulfamoyl fluoride, or both. In addition, the sulfonamide compound may be solely N,N-dimethyltrifluoromethanesulfonamide.

A content of the sulfonamide compound is not particularly limited. In a case where a total mass of the non-aqueous electrolyte solution is set to 100%, the non-aqueous electrolyte solution may contain 1.0% by mass or more of the sulfonamide compound, 5.0% by mass or less of the sulfonamide compound, or 2.0% by mass or less of the sulfonamide compound.

The non-aqueous electrolyte solution contains a cyclic carbonate compound and an ester compound as a solvent. The cyclic carbonate may be, for example, at least one of ethylene carbonate (EC) and propylene carbonate (PC), or may be ethylene carbonate (EC). In addition, the ester compound may be at least one selected from the group including methyl acetate (MA), methyl propionate (MP), ethyl acetate (EA), ethylene propionate (EP), and propyl propionate (PP). The ester compound may be methyl propionate (MP).

A mixing ratio of the cyclic carbonate compound and the ester compound is not particularly limited. For example, a volume ratio (cyclic carbonate compound/ester compound) of the cyclic carbonate compound to the ester compound may be 0.17 or more, 9.00 or less, 6.00 or less, or 1.00 or less.

The non-aqueous electrolyte solution may further contain vinylene carbonate (vinyl carbonic acid (VC)) as an additive. By containing vinylene carbonate, the formation of the SEI in the negative electrode can be further promoted, and the effect of suppressing the decrease in battery performance can be enhanced.

A content of vinylene carbonate in the non-aqueous electrolyte solution is not particularly limited, but in a case where a total mass of the non-aqueous electrolyte solution is set to 100%, the content of vinylene carbonate may be, for example, 1.0% by mass or more, 5.0% by mass or less, or 2.0% by mass or less.

The non-aqueous electrolyte solution may contain an ionic liquid. The ionic liquid may include, for example, at least one selected from the group including a sulfonium salt, an ammonium salt, a pyridinium salt, a piperidinium salt, a pyrrolidinium salt, a morpholinium salt, a phosphonium salt, an imidazolium salt, and a derivative thereof.

### 2. Positive Electrode

The positive electrode includes a positive electrode current collector foil and a positive electrode layer containing a positive electrode active material.

Examples of the material of the positive electrode current collector foil include SUS, Cr, Au, Pt, Zn, aluminum, copper, nickel, iron, titanium, and carbon. A thickness of the positive electrode current collector foil is, for example, 0.1 μm or more and 100 μm or less. A planar shape of the positive electrode current collector foil is not particularly limited, and examples thereof include a circular shape, an elliptical shape, a rectangular shape, and any polygonal shape. The positive electrode current collector foil may have a configuration in which a buffer layer, an elastic layer, or a positive temperature coefficient (PTC) thermistor layer is disposed on a surface thereof.

The positive electrode layer contains lithium manganese iron phosphate (LMFP) as a positive electrode active material. The LMFP is usually in a particle shape, and an average particle diameter thereof may be, for example, 1 μm or more or 30 μm or less.

The positive electrode active material contained in the positive electrode layer may be solely the LMFP, or may be a combination of the LMFP and another positive electrode active material other than the LMFP, but may be solely the LMFP from the viewpoint of durability. As the other positive electrode active material, a known positive electrode active material of a lithium secondary battery can be used. Examples of the other positive electrode active material include lithium metal composite oxides such as LiCoO₂, LiNiO₂, LiMnO₂, LiMn₂O₄, Li(NiCoMn)O₂, and Li(NiCoAl)O₂. Here, “(NiCoMn)” in “Li(NiCoMn)O₂” and “(NiCoAl)” in “Li(NiCoAl)O₂” indicate that the total of the composition ratio in the parentheses is 1, and the composition ratio of each element is optional as long as the total is 1. Li(NiCoMn)O₂ may be, for example, Li(Ni_{1/3}Co_{1/3}Mn_{1/3})O₂, Li(Ni_{0.5}Co_{0.2}Mn_{0.3})O₂, or Li(Ni_{0.8}Co_{0.1}Mn_{0.1})O₂. Li(NiCoAl)O₂ may be, for example, Li(Ni_{0.81}Co_{0.15}Al_{0.04})O₂.

In a case where a total mass of the positive electrode layer is set to 100%, a proportion of the positive electrode active material in the positive electrode layer is, for example, 20% by mass or more, and may be 30% by mass or more or 40% by mass or more, and may be 95% by mass or less or 70% by mass or less.

The positive electrode layer may contain at least one of a conductive material, a binder, a dispersant, and an electrolyte, as needed.

Examples of the conductive material include a carbon-based conductive material, metal particles, and a conductive polymer, and a carbon-based conductive material may be used. Examples of the carbon-based conductive material include particle-shaped materials such as acetylene black (AB) and Ketjen black (KB), and fiber-shaped materials such as vapor-grown carbon fiber (VGCF), carbon nanotube (CNT), and carbon nanofiber (CNF).

In a case where a total mass of the positive electrode layer is set to 100%, a proportion of the conductive material in the positive electrode layer may be, for example, 0.1% by mass or more or 5% by mass or less.

Examples of the binder include styrene-butadiene rubber (SBR), polyimide (PI), polyacrylic acid (PAA), acrylonitrile-butadiene rubber (NBR), butadiene rubber (BR), polyvinylidene fluoride (PVdF), carboxymethyl cellulose (CMC), polytetrafluoroethylene (PTFE), a styrene-isoprene-styrene block copolymer (SIS), and an ethylene-propylene-diene copolymer (EPDM).

In a case where a total mass of the positive electrode layer is set to 100%, a proportion of the binder in the positive electrode layer may be, for example, 0.5% by mass or more or 15% by mass or less.

The dispersant is not particularly limited, and a known dispersant can be used. In a case where a total mass of the positive electrode layer is set to 100%, a proportion of the dispersant in the positive electrode layer may be, for example, 0.1% by mass or more or 1% by mass or less.

The electrolyte may be, for example, an inorganic solid electrolyte such as a sulfide solid electrolyte, a halide solid electrolyte, an oxide solid electrolyte, and a complex hydride solid electrolyte, or may be an organic solid electrolyte such as a gel electrolyte. A proportion of the solid electrolyte in the positive electrode layer may be, for example, 0% to 1% by mass.

A thickness of the positive electrode layer is, for example, 0.1 μm or more and 1,000 μm or less, and may be 1 μm or more and 500 μm or less, or 30 μm or more and 100 μm or less.

The positive electrode layer may be disposed on one surface of the positive electrode current collector foil, or may be disposed on both surfaces of the positive electrode current collector foil.

A method of manufacturing the positive electrode layer is not particularly limited. For example, the positive electrode layer can be provided on the positive electrode current collector foil by preparing a positive electrode slurry by mixing the LMFP, the conductive material, the binder, the dispersant, and a solvent, applying the positive electrode slurry to the positive electrode current collector foil, and drying the positive electrode slurry. A pressing treatment of pressing the positive electrode layer in a thickness direction may be performed. Examples of the pressing treatment include a roller press and a flat plate press. Examples of the solvent of the positive electrode slurry include N-methylpyrrolidone (NMP), tetralin, diisobutyl ketone, butyl butyrate, mesitylene, heptane, dibutyl ether, decane, dodecane, isodecane, and toluene. The solvent of the positive electrode slurry may contain two or more components thereof.

It can be said that the non-aqueous secondary battery according to the present disclosure has a positive electrode layer having a basis weight of 20 mg/cm² or more that is a large basis weight. In a case where the basis weight of the positive electrode layer is large in this way, a side reaction other than a discharge reaction and a charge reaction is likely to proceed, the deterioration of the constituent material proceeds, and the battery performance is likely to decrease, but in the non-aqueous secondary battery according to the present disclosure, it is possible to suppress the progress of the side reaction and to stabilize the battery performance.

The basis weight of the positive electrode layer may be 20 mg/cm² or more, and may be, for example, 100 mg/cm² or less or 50 mg/cm² or less.

### 3. Negative Electrode

The negative electrode includes a negative electrode current collector foil and a negative electrode layer containing a negative electrode active material.

Examples of the material of the negative electrode current collector foil include SUS, aluminum, copper, nickel, iron, titanium, and carbon. In addition, a thickness of the negative electrode current collector foil may be, for example, in a range of 1 μm to 50 μm. A planar shape of the negative electrode current collector foil is not particularly limited, and examples thereof include a circular shape, an elliptical shape, a rectangular shape, and any polygonal shape. The negative electrode current collector foil may have a configuration in which a buffer layer, an elastic layer, or a PTC thermistor layer is disposed on a surface thereof.

The negative electrode layer is a layer containing at least the negative electrode active material. In addition, the negative electrode layer may contain at least one of a conductive material, a binder, and an electrolyte, as needed.

The negative electrode active material may be, for example, in a particle shape or a sheet shape. An average particle diameter of the particles of the negative electrode active material may be, for example, 1 μm or more or 30 μm or less.

The negative electrode active material may include, for example, at least one selected from the group including a carbon-based active material, an Li-based active material, an Si-based active material, a Si—C composite material, and lithium titanate. The carbon-based active material may include, for example, at least one selected from the group including graphite, soft carbon, and hard carbon. The term “graphite” is a general term for natural graphite and artificial graphite. Examples of the Li-based active material include Li, lithium silicate, and an Li alloy. Examples of the Si-based active material include Si, SiO, and an Si alloy. The Si—C composite material indicates a composite material of a carbon-based active material (graphite or the like) and an Si-based active material (Si or the like).

Examples of the conductive material, the binder, and the electrolyte used in the negative electrode layer include the same materials as those described in “2. Positive Electrode” above. In addition, the negative electrode layer may contain a dispersant.

The negative electrode layer may be disposed on one surface of the negative electrode current collector foil, or may be disposed on both surfaces of the negative electrode current collector foil. A method of manufacturing the negative electrode layer is not particularly limited. For example, the negative electrode layer can be provided on the negative electrode current collector foil by preparing a negative electrode slurry by mixing the negative electrode active material, the conductive material, the binder, and water (solvent), applying the negative electrode slurry to the negative electrode current collector foil, and drying the negative electrode slurry.

A basis weight of the negative electrode layer is not particularly limited, and may be, for example, 8.0 mg/cm² or more, 8.9 mg/cm² or more, 100.0 mg/cm² or less, or 50.0 mg/cm² or less.

### 4. Non-Aqueous Secondary Battery

The type of the non-aqueous secondary battery according to the present disclosure is not particularly limited, but is typically a lithium ion battery. A shape of the battery is not particularly limited, and may be, for example, a coin type, a cylindrical type, a square type, a sheet type, a button type, a flat type, or a laminated type. In a case of a battery stack in which a plurality of batteries is laminated, the battery stack may be a monopolar type or a bipolar type.

Examples of an application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, the battery may be used as a power source for driving a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

### Embodiment 1

### Preparation of Non-Aqueous Electrolyte Solution

Each component of the non-aqueous electrolyte solution shown in Table 1 was prepared. That is, LiFSI (imide salt) and LiPF₆ (LiX) were prepared as the lithium salt. LiFSI was weighed such that the LiFSI concentration in the non-aqueous electrolyte solution was 1.0 M, and LiPF₆ was weighed such that the LiPF₆ concentration in the non-aqueous electrolyte solution was 0.4 M. In this case, a concentration ratio (LiFSI/LiX) of LiFSI to LiX was 2.5.

In addition, EC (cyclic carbonate compound) and MP (ester compound) were prepared as the solvent. Each of EC and MP was weighed such that, in a case where the total volume of EC and MP was set to 100%, EC was 15% and MP was 85%. In this case, a volume ratio (A/B) of the cyclic carbonate compound (here, A) to the ester compound (here, B) was 0.176. In addition, DMeTFSA (sulfonamide compound) and VC were prepared as the additives. Each of DMeTFSA and VC was weighed such that, in a case where the total mass of the non-aqueous electrolyte solution was set to 100%, each of DMeTFSA and VC was 1.0% by mass.

The above-described components were mixed to prepare a non-aqueous electrolyte solution.

TABLE 1

| | | Non-aqueous electrolyte solution | | | | | | | | | | | | |
|---|---|---|---|---|---|---|---|---|---|---|---|---|---|---|
| | | | | | | | Solvent | | | | | | | |
| | | | | | | | Cyclic | | | | | Addictive | | |
| | | Lithium salt | | | | | carbonate | | Ester | | | VC | Sulfonamide compound | |
| | Positive | Imide salt | | LiX | | | compound | | compound | | | Addition | Addition | |
| | electrode | Concen- | | Concen- | | | Volume | | Volume | | | amount | amount | |
| | active | tration | | tration | | LiFSI/ | ratio | | ratio | | | % by | % by | |
| | material | M | Type | M | Type | LiX | % | Type | % | Type | A/B | mass | mass | Type |
| Comparative | LMFP | 1.0 | LiFSI | 0.4 | LiPF₆ | 2.5 | 15 | EC | 85 | MP | 0.176 | 1.0 | — | — |
| Example 1 | | | | | | | | | | | | | | |
| Comparative | LMFP | 1.4 | LiFSI | — | — | — | 15 | EC | 85 | MP | 0.176 | 1.0 | — | — |
| Example 2 | | | | | | | | | | | | | | |
| Embodiment 1 | LMFP | 1.0 | LiFSI | 0.4 | LiPF₆ | 2.5 | 15 | EC | 85 | MP | 0.176 | 1.0 | 1.0 | DMeTFSA |
| Embodiment 2 | LMFP | 1.4 | LiFSI | — | — | — | 15 | EC | 85 | MP | 0.176 | 1.0 | 1.0 | DMeTFSA |

### Production of Cell (Non-Aqueous Secondary Battery)

LMFP (positive electrode active material), CNT (conductive material), PVdF (binder), and a dispersant were prepared. LMFP, CNT, and PVdF were dispersed in NMP such that the mass ratio of LMFP:CNT:PVdF:dispersant was 94.32%:1.40%:4.00%:0.28%, thereby preparing a positive electrode slurry. The positive electrode slurry was applied onto an Al foil (positive electrode current collector foil) such that the basis weight was 20 mg/cm², and dried to produce a positive electrode in which a positive electrode layer was provided on the positive electrode current collector foil. On the other hand, artificial graphite (negative electrode active material), CNT (conductive material), CMC (binder), and SBR (binder) were prepared. Artificial graphite, CNT, CMC, and SBR were dispersed in water such that the mass ratio of artificial graphite:CNT:CMC:SBR was 97.170%:0.125%:0.405%:2.300%, thereby preparing a negative electrode slurry. The negative electrode slurry was applied onto a Cu foil (negative electrode current collector foil) such that the basis weight was 8.9 mg/cm², and dried to produce a negative electrode in which a negative electrode layer was provided on the negative electrode current collector foil.

Next, an Al tab was ultrasonically welded to the positive electrode, and a Ni tab was ultrasonically welded to the negative electrode. Subsequently, a laminate in which a separator was interposed between the positive electrode and the negative electrode was produced. The laminate was packed into a laminated exterior body and dried at 80 °C.

The non-aqueous electrolyte solution prepared as described above was charged into the laminated exterior body in a glove box, and the laminated exterior body was sealed with a heat sealer to produce a cell (non-aqueous secondary battery).

### Embodiment 2

As shown in Table 1, the non-aqueous electrolyte solution was prepared and a cell was produced in the same manner as in Embodiment 1, except that solely LiFSI (imide salt) was used as the lithium salt and the LiFSI concentration was set to 1.4 M.

### Comparative Example 1

As shown in Table 1, the non-aqueous electrolyte solution was prepared and a cell was produced in the same manner as in Embodiment 1, except that DMeTFSA (sulfonamide compound) was not used.

### Comparative Example 2

As shown in Table 1, the non-aqueous electrolyte solution was prepared and a cell was produced in the same manner as in Embodiment 2, except that DMeTFSA (sulfonamide compound) was not used.

### Evaluation of Cell

### Initial Conditioning

The cells produced in Embodiments 1 and 2 and Comparative Examples 1 and 2 as described above were evaluated as follows. The results are shown in Table 2.

The following treatment was performed as initial conditioning. That is, first, the cell was CC-charged at 0.05 C to 4.3 V at 25 °C. Next, the cell was allowed to stand at 60 °C for 20 hours. Thereafter, the cell was CCCV-charged at 0.1 C to 4.3 V at 25 °C, and CC-discharged at 0.2 C to 2.5 V.

### Initial IV Resistance Measurement

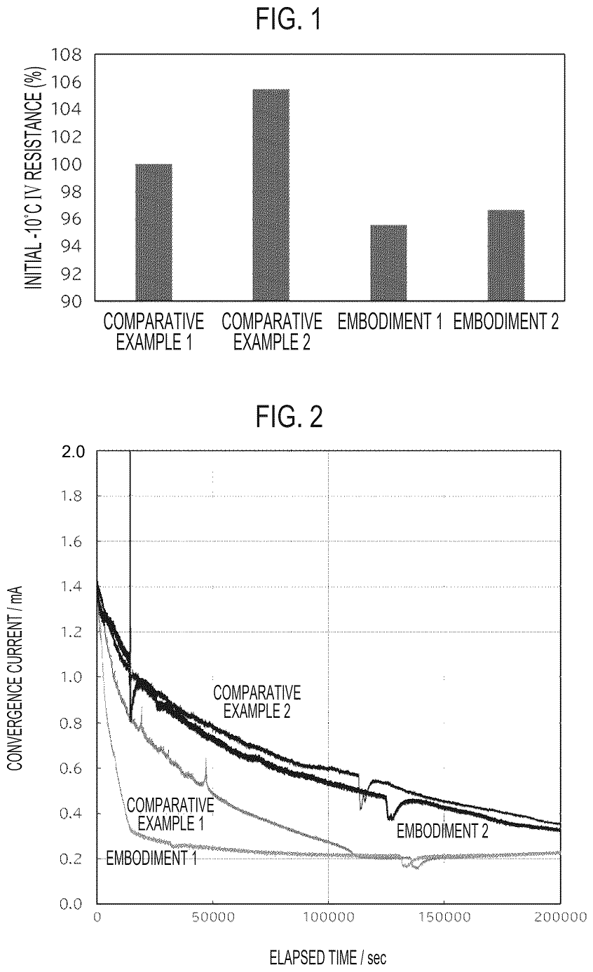

The voltage drop (V) in a case where the cell subjected to the initial conditioning was discharged for 10 seconds under the conditions of each C-rate of 0.5 C, 1.0 C, and 1.5 C at −10 °C was measured. The relationship between the voltage drop (V) and the current value was plotted, and the slope of the approximate straight line in a case where the relationship was approximated by a linear function was defined as the initial IV resistance. The initial IV resistances of Comparative Example 2 and Embodiments 1 and 2 were standardized with the initial IV resistance of Comparative Example 1 as a reference (100%). FIG. 1 is a graph showing an initial IV resistance of embodiments and Comparative Examples.

### Float Test

The cell subjected to the initial conditioning was subjected to a float test of maintaining 4.3 V by CV charging with an external power supply at 60 °C for 1 week. During the float test, the current value of the cell was measured.

FIG. 2 is a graph showing a relationship between an elapsed time and a convergence current (mA) in the float test of the embodiments and Comparative Examples. It is noted that FIG. 2 shows the results from the start of the float test to 200,000 seconds later.

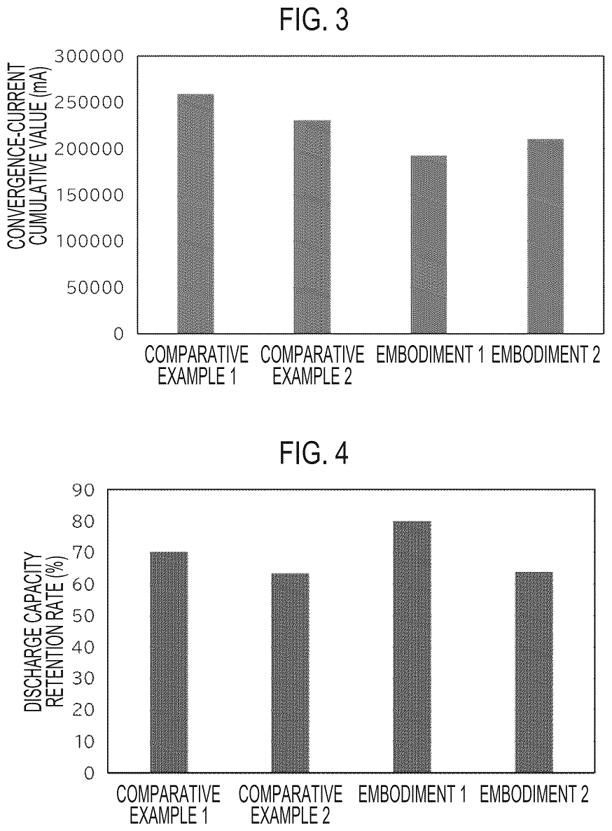

In addition, the measured convergence current values during the float test were integrated. FIG. 3 is a graph showing a convergence-current cumulative value (mA) of the embodiments and Comparative Examples.

### Discharge Capacity Retention Rate

The discharge capacity of the cell subjected to the initial conditioning and the cell after the float test was measured. That is, each cell was CCCV-charged at 0.1 C to 4.3 V at 25 °C, and CC-discharged at 0.1 C to 2.5 V, and the discharge capacity was measured. The discharge capacity retention rate after the float test was calculated from the following expression.

Discharge capacity retention rate=(discharge capacity after float test)/(initial discharge capacity)×100%

FIG. 4 is a graph showing a discharge capacity retention rate of the embodiments and Comparative Examples.

### IV Resistance Increase Rate

The IV resistance of the cell subjected to the float test was calculated in the same manner as in the initial IV resistance measurement.

The IV resistance increase rate after the float test was calculated from the following expression.

IV resistance increase rate=(IV resistance after float test)/(initial IV resistance)×100%

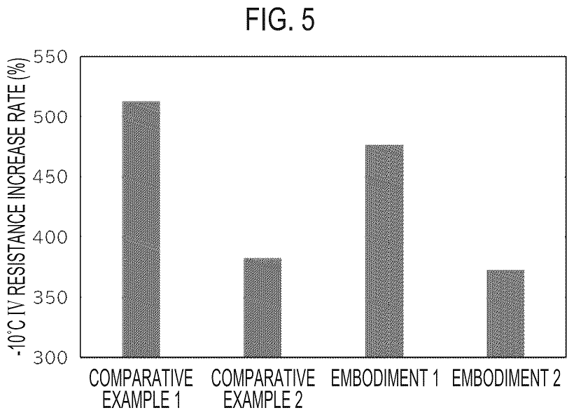

FIG. 5 is a graph showing an IV resistance increase rate of the embodiment and Comparative Examples.

TABLE 2

| | | Convergence- | Discharge | IV |
|---|---|---|---|---|
| | | current | capacity | resistance |
| | Initial IV | cumulative | retention | increase |
| | resistance | value | rate | rate |
| | % | mA | % | % |
| Comparative | 100.0 | 258905 | 70 | 513 |
| Example 1 | | | | |
| Comparative | 105.4 | 230449 | 63 | 383 |
| Example 2 | | | | |
| Embodiment | 95.5 | 192665 | 80 | 476 |
| 1 | | | | |
| Embodiment | 96.6 | 210636 | 64 | 373 |
| 2 | | | | |

As shown in Table 2 and FIG. 1, it was confirmed that, as compared with Comparative Examples 1 and 2, the cells (non-aqueous secondary batteries) of Embodiments 1 and 2 had a low initial IV resistance and exhibited high battery performance even in a severe environment of −10 °C.

In addition, as shown in Table 2 and FIG. 3, the cells of Embodiments 1 and 2 had a smaller convergence-current cumulative value than those of Comparative Examples 1 and 2. This means that, in the cells of Embodiments 1 and 2, the discharge due to the side reaction during the float test was smaller than that in the cells of Comparative Examples 1 and 2. That is, it can be said that the cells of Embodiments 1 and 2 are unlikely to cause a side reaction even in a severe environment of 60 °C.

Furthermore, as shown in Table 2 and FIG. 4, the discharge capacity retention rate of Embodiment 1 was higher than that of Comparative Example 1 that was different from Embodiment 1 solely in that the sulfonamide compound (DMeTFSA) was not contained. In addition, Embodiment 2 exhibited the same discharge capacity retention rate as Comparative Example 2 that was different from Embodiment 2 solely in that the sulfonamide compound (DMeTFSA) was not contained. That is, it was confirmed that the cells of Embodiments 1 and 2 had a stable battery performance and the discharge capacity was unlikely to decrease even after exposure to a severe environment of 60 °C. In particular, the cell of Embodiment 1 has excellent battery performance stability.

In addition, as shown in Table 2 and FIG. 5, it was confirmed that the IV resistance increase rate of Embodiment 1 was low from the comparison between Embodiment 1 and Comparative Example 1. Similarly, from the comparison between Embodiment 2 and Comparative Example 2, it was found that the resistance increase rate of Embodiment 2 was slightly lower. That is, it was confirmed that the non-aqueous secondary batteries of Embodiments 1 and 2 had stable battery performance and the resistance was unlikely to increase even after exposure to a severe environment of 60 °C.

Embodiment 1 in which LiFSI and LiPF₆ were used as the lithium salt was compared with Embodiment 2 in which solely LiFSI was used as the lithium salt. As a result, as shown in Table 2, in the IV resistance increase rate (FIG. 5), Embodiment 2 exhibited a lower value than Embodiment 1, indicating excellent performance. On the other hand, in the initial IV resistance value (FIG. 1), the convergence-current cumulative value (FIG. 3), and the discharge capacity retention rate (FIG. 4), Embodiment 1 exhibited a higher performance than Embodiment 2.

What is claimed is:

1. A non-aqueous secondary battery comprising:
a positive electrode current collector foil;
a positive electrode layer containing a positive electrode active material;
an electrolyte layer containing a separator and a non-aqueous electrolyte solution;
a negative electrode layer; and
a negative electrode current collector foil, wherein:
the positive electrode active material is lithium manganese iron phosphate (LMFP);
a basis weight of the positive electrode layer is 20 mg/cm² or more;
the non-aqueous electrolyte solution contains lithium bis(fluorosulfonyl)imide (LiFSI) as a lithium salt, a sulfonamide compound as an additive, and a cyclic carbonate compound and an ester compound as a solvent;
a concentration of the lithium salt in the non-aqueous electrolyte solution is 1.4 M or more; and
the sulfonamide compound is at least one of N,N-dimethyltrifluoromethanesulfonamide (CF₃SO₂N(CH₃)₂) and N,N-dimethylsulfamoyl fluoride ((CH₃)₂NSO₂F).

2. The non-aqueous secondary battery according to claim 1, wherein:
a volume ratio of the cyclic carbonate compound to the ester compound is 0.17 or more;
the cyclic carbonate compound is at least one of ethylene carbonate (EC) and propylene carbonate (PC); and
the ester compound is at least one selected from the group consisting of methyl acetate (MA), methyl propionate (MP), ethyl acetate (EA), ethylene propionate (EP), and propyl propionate (PP).

3. The non-aqueous secondary battery according to claim 1, wherein:
the non-aqueous electrolyte solution further contains vinylene carbonate (VC) as the additive;
1.0% by mass or more of the vinylene carbonate is contained, as the additive, in the non-aqueous electrolyte solution; and
1.0% by mass or more of the sulfonamide compound is contained, as the additive, in the non-aqueous electrolyte solution.

4. The non-aqueous secondary battery according to claim 1, wherein:
the non-aqueous electrolyte solution further contains LiX as the lithium salt; and
the LiX is at least one of LiPF₆ and LiBF₄.

5. The non-aqueous secondary battery according to claim 4, wherein a concentration ratio of the LiFSI to the LiX (LiFSI/LiX) is 2.5 or more, the LiFSI and the LiX being contained in the non-aqueous electrolyte solution.
